(19) United States
(12) Patent Application Publication
(10) Pub. No.: US 2009/0257748 A1
(43) Pub. Date: Oct. 15, 2009

(54) OPTICAL TRANSMISSION APPARATUS AND OPTICAL TRANSMISSION METHOD

(75) Inventor: Nobuyuki NEMOTO, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/488,699

(22) Filed: Jun. 22, 2009

Related U.S. Application Data
(63) Continuation of application No. PCT/JP2006/326252, filed on Dec. 28, 2006.

(30) Foreign Application Priority Data
Oct. 7, 2008 (WO) 2008/081545

(51) Int. Cl. H04B 10/20; H04J 14/00; H04B 10/04; H04B 10/12

(52) U.S. Cl. 398/49; 398/196; 398/81; 398/147

(57) ABSTRACT

An optical transmission apparatus that performs optical transmission by wavelength multiplexing includes a receiving unit that receives a first optical signal transmitted from a transmitting device; a wavelength determining unit that determines wavelength of the first optical signal received by the receiving unit; a transmitting unit that transmits a second optical signal of varying wavelength; and a control unit that, based on the wavelength determined by the wavelength determining unit, controls wavelength of the second optical signal transmitted by the transmitting unit.

### CROSS REFERENCE TO RELATED APPLICATION

This is a continuation application of PCT/JP2006/326252 filed on Dec. 28, 2006, the contents of which are incorporated herein by reference.

### FIELD

The embodiments discussed herein are related to an optical transmission apparatus and an optical transmission method with which optical transmission is performed by wavelength multiplexing.

### BACKGROUND

In recent years, with the increase in transmission capacity, networks supporting dense wavelength division multiplexing (DWDM) are being developed. Moreover, to respond to further increases in transmission capacity, an ultrahigh speed optical transmission system having a transmission speed of 40 gigabytes per second (Gbps) is being commercialized. Under such circumstances, a simple transponder system (standalone transponder system) that enables transmission from a router to buildings of users, while maintaining a high speed has been developed (for example, Japanese Laid-Open Patent Publication No. 2000-349753).

FIG. 13 is a block diagram of a conventional WDM transmission system. In a station A, a synchronous optical network/synchronous digital hierarchy (SONET/SDH) signal output from a router 1301 is received and subjected to transparent transmission (converted to an optical wavelength for wavelength multiplexing) by a transponder 1302. The signal is wavelength multiplexed by a multiplexer (MUX) 1303 and transmitted to a station F. In long-haul transmission, SONET/SDH signals are transmitted from the station A to the station F via repeaters B to E.

At the station F, the SONET/SDH signal transmitted from the station A is extracted by the MUX 1304 and is transferred to a router 1306 through a transponder 1305. In this WDM transmission system, the wavelength of optical signals transmitted from the station A to the station F is λ1, and the wavelength of optical signals transmitted from the station F to the station A is λ2 (≠λ1).

FIG. 14 is another block diagram of a conventional WDM transmission system. As depicted in FIG. 14, the WDM transmission system includes stations H to M to form a redundant path for the connection from the station A to the station F. A transponder 1401 of the station A, transponders 1402 and 1403 of the station F, and a transponder 1404 of the station G are simple transponders that are necessary particularly for long distance transmission. The station G is an optical transmission apparatus that is provided in a building of a user, and constitutes an independent transponder system. The paths of this WDM transmission system support optical signals of wavelengths λ3 and λ4, respectively and irrespective of direction, the optical signals in a given path are of the same wavelength.

FIG. 15 is a block diagram of a conventional DWDM apparatus. A DWDM apparatus 1500 depicted in FIG. 15 is an optical transmission apparatus that included in the station G depicted in FIG. 14, for example. The DWDM apparatus 1500 includes a transponder (TRPN) 1501 that transmits and receives data and a control unit 1502 that is a control system controlling the transmission and reception of data by the transponder 1501.

The control unit 1502 is connected to a network management system (NMS) 1510, and controls the transmission and reception of data in the DWDM apparatus 1500 under the control of the NMS 1510. The control unit 1502, for example, receives from the NMS 1510, information concerning the wavelength assigned to the DWDM apparatus 1500 and controls the wavelength of optical signals transmitted and received by the transponder 1501 based on the information received.

FIG. 16 is a block diagram depicting a part of a configuration of a conventional optical transmission system. As depicted in FIG. 16, a conventional optical transmission system 1600 includes a WDM apparatus 1610, an optical transmission apparatus 1620, and an NMS 1630. A control unit 1611 in the WDM apparatus 1610 receives from the NMS 1630, information concerning the wavelength that is assigned to optical signals communicated with the optical transmission apparatus 1620 and controls the wavelength of optical signals transmitted and received by the transponder 1612 based on the information received.

Similarly, a control unit 1621 in the optical transmission apparatus 1620 receives from the NMS 1630, information concerning the wavelength that is assigned to optical signals communicated with the WDM apparatus 1610 and controls the wavelength of optical signals transmitted and received by the transponder 1622 based on the information received. A MUX 1613 in the WDM apparatus 1610 performs multiplex division of optical signals transmitted from other optical transmission apparatuses, and multiplexes optical signals that are transmitted to other optical transmission apparatuses.

Furthermore, in a high-speed optical transmission apparatus, a dispersion compensator such as a virtually imaged phased array (VIPA) is used to compensate deterioration of optical signals caused by wavelength dispersion. VIPA is dependent on the wavelength of optical signals received thereby, and wavelength deviation may occur depending on the wavelength of the signals received. Therefore, the optical transmission apparatus receives from an NMS, information concerning the wavelength of received optical signals by a control system, and performs temperature control of the VIPA according to the wavelength of the optical signals received.

Moreover, on a sending side of a transponder of optical transmission apparatuses, a tunable laser diode (LD) that can change transmission wavelength is used. An optical transmission apparatus receives by a control system and from an NMS, information concerning the transmission wavelength that is assigned for transmission by the optical transmission apparatus, and sets the assigned transmission wavelength in the tunable LD.

However, for example, the transponder that is installed in a building of a user must be space saving because installation space is limited in the building. In addition, if a control system is provided in each of such transponders, cost increases. Although omission of the control system controlling the transponder may be considered from the point of view of reducing space and cost, alarm detection and remote operation are disabled if the control system is removed.

Moreover, if the control system of the transponder is omitted, information concerning the wavelength that is assigned to the transponder cannot be obtained and temperature control of VIPA cannot be performed appropriately. As a result, the accuracy of dispersion compensation is degraded. Furthermore, if the control system is omitted, information concerning the wavelength that is assigned to the transponder cannot be obtained and the setting of the transmission wavelength cannot be performed.

### SUMMARY

According to an aspect of an embodiment, an optical transmission apparatus that performs optical transmission by wavelength multiplexing includes a receiving unit that receives a first optical signal transmitted from a transmitting device; a wavelength determining unit that determines wavelength of the first optical signal received by the receiving unit; a transmitting unit that transmits a second optical signal of varying wavelength; and a control unit that, based on the wavelength determined by the wavelength determining unit, controls wavelength of the second optical signal transmitted by the transmitting unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram depicting a part of an optical transmission system to which an optical transmission apparatus according to a first embodiment is applied;

FIG. 2 is a block diagram depicting a configuration of a dispersion compensating unit of an optical transmission apparatus according to a second embodiment;

FIG. 3 is a block diagram depicting a state of a dispersion compensating unit of an optical transmission apparatus according to a third embodiment;

FIG. 4 is a block diagram depicting another state of the dispersion compensating unit of the optical transmission apparatus according to the third embodiment;

FIG. 5 is a block diagram of an optical transmission apparatus according to the third embodiment;

FIG. 6 is a flowchart of one example of an operation of the optical transmission apparatus according to the third embodiment;

FIG. 7 is a block diagram of a wavelength determining unit of an optical transmission apparatus according to a fourth embodiment;

FIG. 8 is a block diagram depicting a part of an optical transmission system to which an optical transmission apparatus according to a fifth embodiment is applied;

FIG. 9 is a flowchart of an operation of the optical transmission system to which the optical transmission apparatus according to the fifth embodiment is applied;

FIG. 10 is a block diagram depicting a part of an optical transmission system to which an optical transmission apparatus according to a sixth embodiment is applied;

FIG. 11 is a block diagram depicting a basic configuration of an example of a DWDM apparatus to which the optical transmission apparatus according to the present embodiments is applied;

FIG. 12 is a block diagram depicting a configuration of an example of the transponder of the optical transmission apparatus according to the present embodiments;

FIG. 13 is a block diagram of a conventional WDM transmission system;

FIG. 14 is a block diagram of another conventional WDM transmission system;

FIG. 15 is a block diagram of a conventional DWDM apparatus; and

FIG. 16 is a block diagram depicting a part of a configuration of a conventional optical transmission system.

### DESCRIPTION OF EMBODIMENTS

Preferred embodiments of the present invention will be explained with reference to the accompanying drawings.

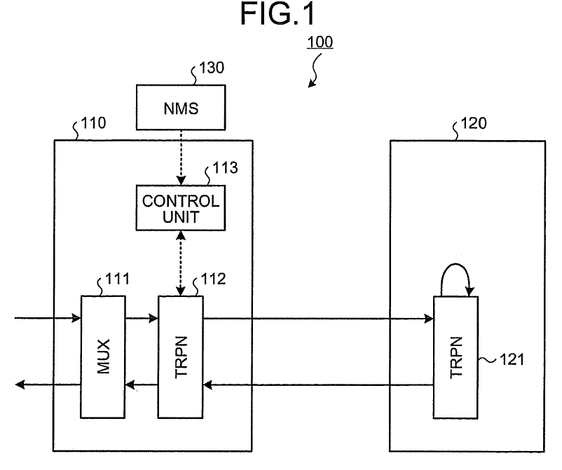

FIG. 1 is a block diagram depicting a part of an optical transmission system to which an optical transmission apparatus according to a first embodiment is applied. In FIG. 1 (as well as in other block diagrams), the flow of actual data signals are indicated by solid lines and the flow of control signals are indicated by dotted lines. As depicted in FIG. 1, an optical transmission system 100 includes a WDM apparatus 110, an optical transmission apparatus 120, and an NMS 130.

The WDM apparatus 110 includes a multiplexer (MUX) 111, a transponder (TRPN) 112, and a control unit 113. The multiplexer 111 receives a wavelength multiplexed optical signal transmitted from another optical transmission apparatus in the optical transmission system 100, demultiplexes the wavelength multiplexed optical signal received. The multiplexer 111 outputs the optical signal resulting from the demultiplexing to the transponder 112. Moreover, the multiplexer 111 performs wavelength multiplexing on optical signals transmitted from the transponder 112 and sends the resulting multiplexed optical signal to other optical transmission apparatuses in the optical transmission system 100.

The transponder 112 transmits to the optical transmission apparatus 120, the optical signal output from the multiplexer 111. Further, the transponder 112 receives an optical signal transmitted from the optical transmission apparatus 120 and outputs the optical signal received to the multiplexer 111. The control unit 113 is connected to the NMS 130, and controls the transmission and reception of optical signals by the transponder 112.

Moreover, the control unit 113, using SONET/SDH overhead, transmits to the optical transmission apparatus 120, information concerning the wavelength to be used when the optical transmission apparatus 120 sends an optical signal. For the overhead by which the information concerning wavelength is sent, for example, D1 to D3 (direct client-to-client (DCC)) bytes, E1 (order wire) byte, F1 (user) byte, or the like is selected depending on a condition of the apparatus.

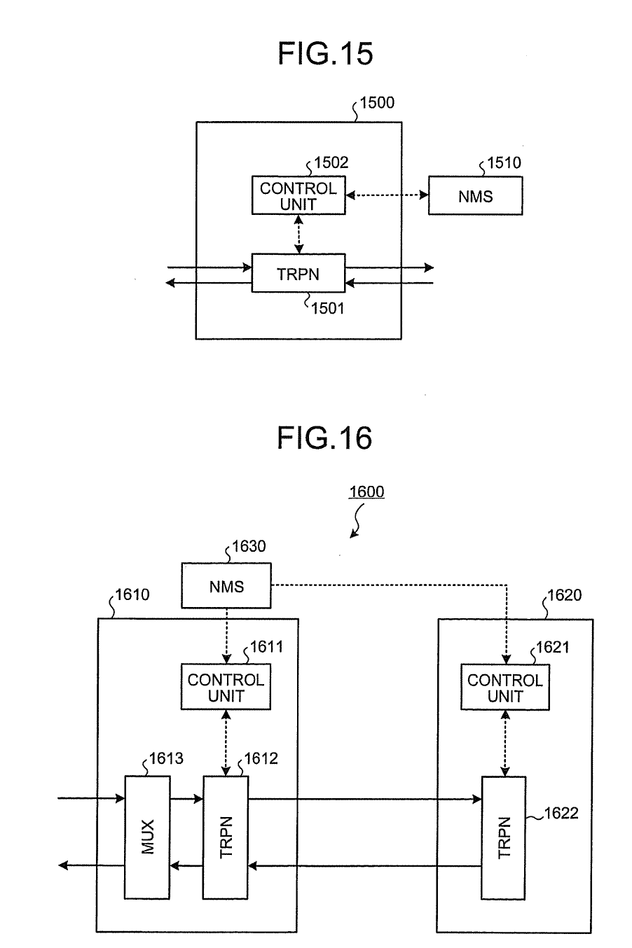

The optical transmission apparatus 120 is configured with the transponder 121, and a control system such as that depicted in FIG. 15 (the control unit 1502) is omitted therein. The optical transmission apparatus 120 is installed in a building of a user or the like and constitutes an independent transponder system. The transponder 121 receives an optical signal transmitted from the WDM apparatus 110, and detects alarm information.

Alarm information is information concerning a detected alarm of SONET/SDH, digital wrapper (DW) such as loss of signal (LOS) and loss of frame (LOF). The transponder 121 transmits the detected alarm information as is using SONET/SDH overhead. Thus, the WDM apparatus 110 can acquire the alarm information of the optical transmission apparatus 120 and the optical transmission apparatus 120 can communicate with the WDM apparatus 110 even if configured without a control system.

Moreover, an initial setting value at the time of starting the transponder 121 are stored in an electronically erasable and programmable read only memory (EEPROM) included in the transponder 121 in advance, and is read when the transponder 121 is started. Thus, the initial setting value at the time of starting the transponder 121 can be set. Furthermore, the transponder 121 receives information concerning the wavelength that is used when the optical transmission apparatus 120 transmits an optical signal, and sets the transmission wavelength based on the information received.

As described, according to the optical transmission apparatus 120 of the first embodiment, by directly returning detected alarm information without passing through a control system, the WDM apparatus 110 can acquire the alarm information without a control system. Moreover, the optical transmission apparatus 120 according to the first embodiment, by receiving wavelength information transmitted from the WDM apparatus 110 using available overhead, can set the transmission wavelength without a control system. Therefore, the optical transmission apparatus 120 according to the first embodiment enables a space-saving and low cost apparatus to be achieved.

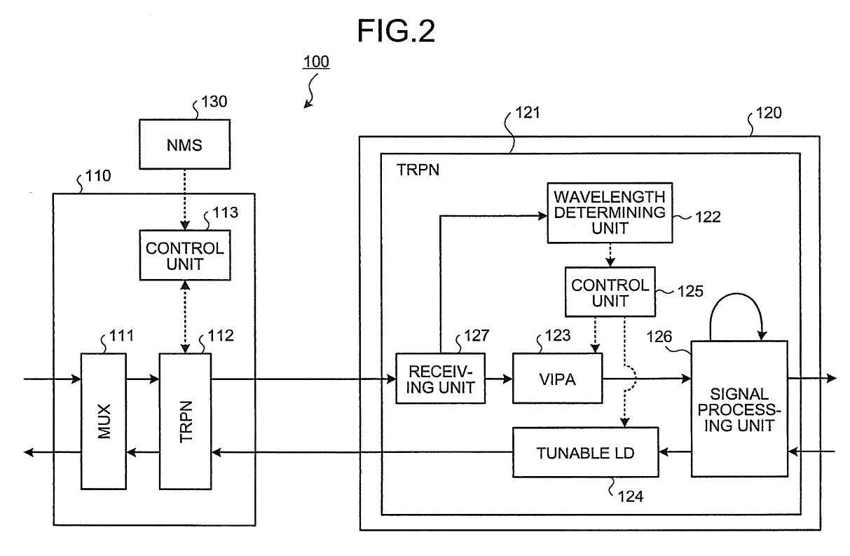

FIG. 2 is a block diagram depicting a configuration of a dispersion compensating unit of an optical transmission apparatus according to a second embodiment of the present invention. Like reference numerals refer to like components in FIG. 1 and FIG. 2, and the explanation therefor is omitted. As depicted in FIG. 2, the optical transmission apparatus 120 includes the transponder 121. The transponder 121 includes a receiving unit 127, a wavelength determining unit 122, a dispersion compensating unit (VIPA) 123, a transmitting unit (tunable LD) 124, a control unit 125, and a signal processing unit 126.

The receiving unit 1127 receives an optical signal transmitted from the WDM apparatus 110. The receiving unit 127 outputs the received optical signal to the wavelength determining unit 122 and the dispersion compensating unit 123. The wavelength determining unit 122 determines the wavelength of the optical signal output from the receiving unit 127. The wavelength determining unit 122 may be configured with, for example, a common wavelength meter. The wavelength determining unit 122 outputs to the control unit 125, information concerning the determined wavelength of the optical signal.

The dispersion compensating unit 123 performs dispersion compensation on the optical signal output from the receiving unit 127. The level of dispersion compensation performed by the dispersion compensating unit 123 is variable. The dispersion compensating unit 123 changes the level of dispersion compensation under the control of the control unit 125. In this example, the dispersion compensating unit 123 is configured with a VIPA. The dispersion compensating unit 123 outputs to the signal processing unit 126, the optical signal that has been subjected to dispersion compensation.

The transmitting unit 124 converts an electrical signal output from the signal processing unit 126 into an optical signal and outputs the optical signal to the WDM apparatus 110. The transmitting unit 124, under the control of the control unit 125, changes the wavelength of the optical signal to be sent. In this example, the transmitting unit 124 is configured with a tunable LD.

The control unit 125, based on the information concerning the wavelength of the optical signal output from the wavelength determining unit 122, controls the level of dispersion compensation performed by the dispersion compensating unit 123. Specifically, the control unit 125 performs temperature control of a multi-reflective plate of the VIPA constituting the dispersion compensating unit 123. Furthermore, the control unit 125, based on the information that concerns the wavelength of the optical signal and is output from the wavelength determining unit 122, controls the wavelength of the optical signal that is transmitted by the transmitting unit 124. Specifically, the control unit 125 sets the wavelength of the optical signal to be transmitted from the transmitting unit 124, to be the wavelength of the optical signal that is transmitted from the WDM apparatus 110 to the optical transmission apparatus 120.

The signal processing unit 126 performs signal processing on the optical signal output from the dispersion compensating unit 123. For example, the signal processing unit 126 performs demodulation processing on the optical signal output from the dispersion compensating unit 123. Moreover, the signal processing unit 126 performs error correction processing (forward error correction (FEC)) on the optical signal output from the dispersion compensating unit 123, and calculates the bit error rate (BER) of the optical signal received by the optical transmission apparatus 120.

The signal processing unit 126 outputs to, for example, a user terminal, a data signal that is obtained as a result of the signal processing. Furthermore, the signal processing unit 126 performs demodulation processing on a data string output from the user terminal, for example, and outputs to the transmitting unit 124 as an electrical signal, a data signal obtained as a result of the demodulation processing. Furthermore, the signal processing unit 126, using SONET/SDH overhead, transmits (as is) alarm information detected from the received optical signal.

As described, according to the optical transmission apparatus 120 of the second embodiment, the wavelength of a received optical signal can be determined without passing through a control system. Accordingly, a control system can be omitted while the setting of the transmission wavelength is enabled. Thus, according to the optical transmission apparatus 120 of the second embodiment, a space-saving and low cost apparatus can be achieved.

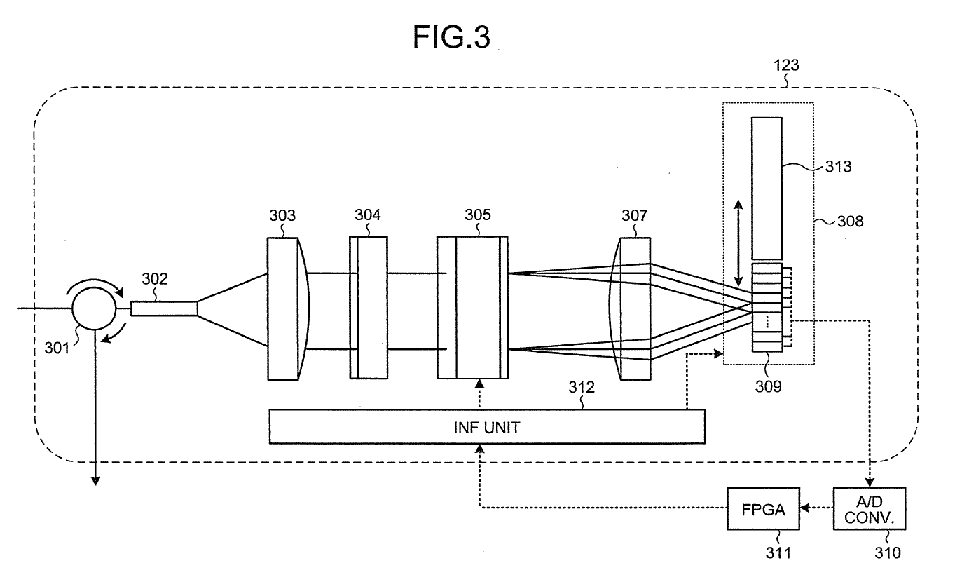

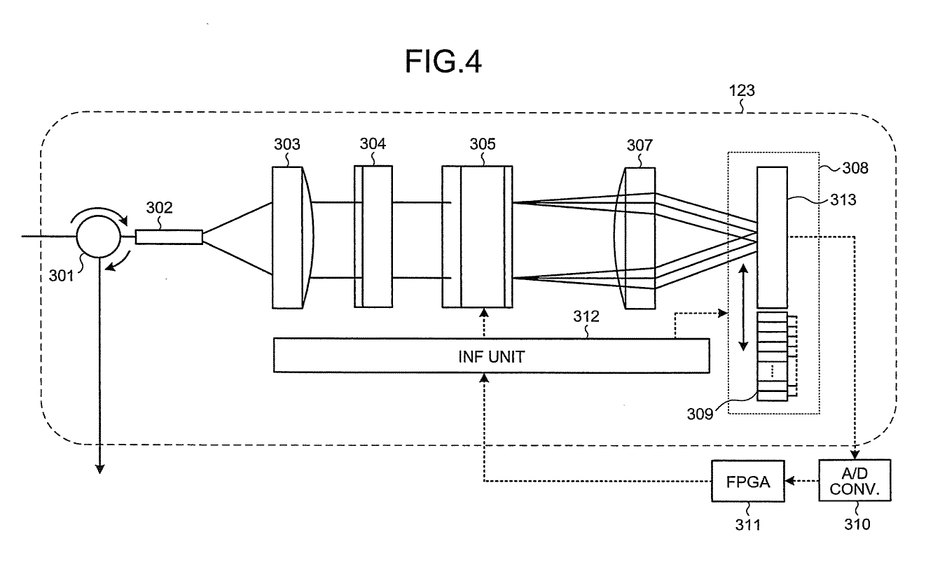

FIG. 3 is a block diagram depicting a state of a dispersion compensating unit of an optical transmission apparatus according to a third embodiment of the present invention. FIG. 4 is a block diagram depicting another state of the dispersion compensating unit of the optical transmission apparatus according to the third embodiment. As depicted in FIGS. 3 and 4, the dispersion compensating unit 123 according to the third embodiment includes a switching unit 308, a photo diode (PD) array 309, a digital converting unit 310, and a control unit 311, in addition to an optical circulator 301, a single mode fiber 302, a collimator lens 303, a line focus lens 304, a multi-reflective plate 305, a focus lens 307, and a mirror 313.

The optical circulator 301 outputs 120 to the single mode fiber 302, an optical signal received by the optical transmission apparatus. Moreover, the optical circulator 301 outputs to the signal processing unit 126, an optical signal output from the single mode fiber 302.

The single mode fiber 302 outputs in the form of diffused light and to the collimator lens 303, the optical signal output from the optical circulator 301. The transmission position of the single mode fiber 302 to output the optical signal to the collimator lens 303 corresponds to a focal point of the collimator lens 303. Furthermore, the single mode fiber 302 outputs to the optical circulator 301, an optical signal output from the collimator lens 303.

The collimator lens 303 collimates the optical signal output from the single mode fiber 302 and outputs the optical signal in the form of parallel light to the line focus lens 304. Further, the collimator lens 303 converges an optical signal output from the line focus lens 304 and outputs the optical signal in the form of converging light to the single mode fiber 302. The line focus lens 304 converges the optical signal output from the collimator lens 303 on a surface of the multi-reflective plate 305. Moreover, the line focus lens 304 outputs in the form of parallel light and to the collimator lens 303, an optical signal output from the multi-reflective plate 305.

The multi-reflective plate 305 multi-reflects the optical signal converged thereto by the line focus lens 304 and outputs the multi-reflected optical signal to the focus lens 307 at an angle corresponding to the wavelength of the optical signal. Thus, the optical signal is separated into optical signals according to wavelength. Moreover, the multi-reflective plate 305 respectively outputs to the line focus lens 304, optical signals that are output from the focus lens 307. The multi-reflective plate 305 outputs the optical signals at angles corresponding to the wavelengths of the optical signals.

The focus lens 307 converges an optical signal output from the multi-reflective plate 305 and outputs the optical signal as converged light to the PD array 309. Alternatively, the focus lens 307 converges an optical signal output from the multi-reflective plate 305 and reflects the optical signal in the form of converged light on the mirror 313. Further, the focus lens 307 outputs to the multi-reflective plate 305, an optical signal that has been reflected to the focus lens 307 by the mirror 313. The focus lens 307 outputs the optical signal at an angle corresponding to the wavelength of the optical signal.

The switching unit 308 mechanically changes the positions of the PD array 309 and the mirror 313. Specifically, when the wavelength of an optical signal that is received by the optical transmission apparatus 120 is measured, the switching unit 308 positions the PD array 309 so that the optical signal reflected by the multi-reflective plate 305 is received, as depicted in FIG. 3.

The PD array 309 receives an optical signal that is output from the focus lens 307. The PD array 309 includes plural light receiving elements. The light receiving elements respectively correspond to various wavelengths, and are arranged at positions where corresponding optical signals are received. The PD array 309 converts the intensity of the optical signals that are received by the light receiving elements into electrical signals that are output to the digital converting unit 310. The digital converting unit (analog digital converter (AD/CONV)) 310 converts the electrical signal output from the PD array 309 into a digital signal that is output to the control unit (field programmable gate array (FPGA)) 311.

The control unit 311 acquires the digital signal output from the digital converting unit 310, and determines the wavelength of the received optical signal by determining which light receiving element has received an optical signal having a high intensity. For example, the control unit 311 determines the wavelength corresponding to the light receiving element that has received the optical signal having the highest intensity as the wavelength of the received optical signal. The control unit 311, based on information concerning the determined wavelength, performs temperature control of the multi-reflective plate 305 through an interface (INF) unit 312.

Moreover, the control unit 311 mechanically changes the positions of the PD array 309 and the mirror 313 by controlling the PD array 309 through the interface unit 312. In this example, the control unit 311 is configured with FPGA. The interface unit 312 is configured with an inter integrated circuit (12C).

When dispersion compensation is performed on an optical signal received by the optical transmission apparatus 120, the switching unit 308 positions the mirror 313 such that the mirror 313 reflects an optical signal that has been reflected by the multi-reflective plate 305, as depicted in FIG. 4. The mirror 313 reflects to the focus lens 307, an optical signal output from the focus lens 307. The mirror 313 is a free-form mirror whose reflective surface continuously varies. Because optical signals that are output from the multi-reflective plate 305 take different optical paths depending on the wavelength of the optical signal, the optical signals are reflected at different positions on the mirror 313 depending on the wavelength. This enables the dispersion compensating unit 123 to induce different dispersion compensation levels for respective wavelengths.

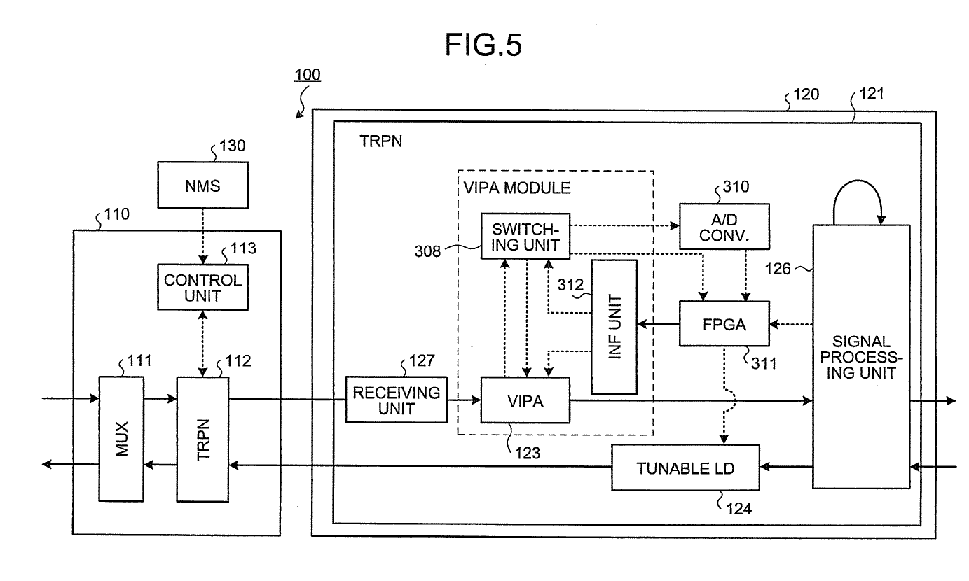

FIG. 5 is a block diagram of an optical transmission apparatus according to the third embodiment of the present invention. Like reference numerals refer to like components in FIG. 2 and FIG. 5, and the explanation therefor is omitted. As depicted in FIG. 5, the transponder 121 of the optical transmission apparatus 120 according to the third embodiment includes the receiving unit 127, the dispersion compensating unit 123, the transmitting unit 124, the signal processing unit 126, the switching unit 308, the digital converting unit 310, the control unit 311, and the interface unit 312. The dispersion compensating unit 123, the switching unit 308, and the interface unit 312 constitute a VIPA module.

The control unit 311 controls the level of dispersion compensation by the dispersion compensating unit 123 and the setting of the transmission wavelength of the transmitting unit 124, in addition to controlling the temperature of the multi-reflective plate 305. The control unit 311 adjusts the distance between the mirror 313 and the focus lens 307, thereby controlling the level of dispersion compensation with respect to each wavelength of the optical signals. Specifically, the control unit 311 obtains information concerning BER from the signal processing unit 126, and adjusts the mirror 313 so as to minimize BER. Moreover, the control unit 311 sets the transmission wavelength of the transmitting unit 124 based on information concerning the determined wavelength.

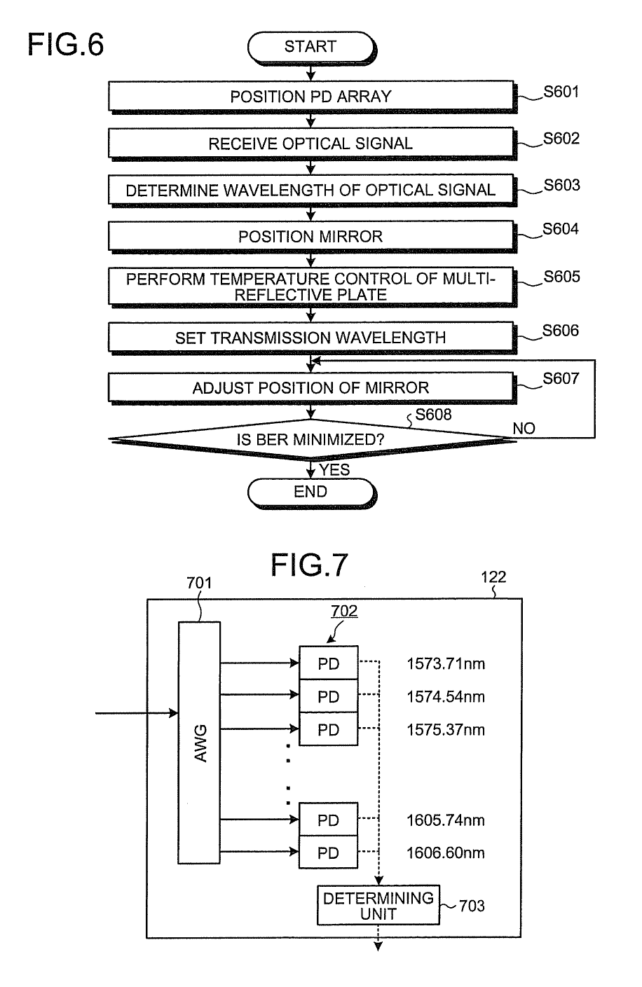

FIG. 6 is a flowchart of one example of an operation of the optical transmission apparatus according to the third embodiment. First, the switching unit 308 positions the PD array 309 such that an optical signal reflected by the multi-reflective plate 305 is received (step S601). Next, an optical signal transmitted from the WDM apparatus 110 is received (step S602). Subsequently, the control unit 311 determines wavelength of the received optical signal (step S603). Next, the switching unit 308 positions the mirror 313 such that the mirror 313 reflects the optical signal that has been reflected by the multi-reflective plate 305 (step S604).

Subsequently, the control unit 311 performs temperature control of the multi-reflective plate 305 based on information concerning the wavelength determined at step S603 (step S605). Next, the control unit 311 sets the transmission wavelength of the transmitting unit 124 based on the information concerning wavelength determined at step S603 (step S606). The control unit 311 then adjusts the position of the mirror 313 (step S607), and continues adjusting the position until BER is minimized (step S608: NO). When BER is minimized (step S608: YES), data communication begins.

As described, the wavelength determining unit 122 of the optical transmission apparatus 120 according to the third embodiment determines a reflection angle of an optical signal at the multi-reflective plate 305 of the dispersion compensating unit 123, thereby determining the wavelength of the optical signal. Thus, according to the optical transmission apparatus 120 of the third embodiment, the wavelength of a received optical signal can be determined using a VIPA component. Therefore, a control system can be omitted while enabling the setting of transmission wavelength through a simple and space-saving configuration. Therefore, according to the optical transmission apparatus 120 of the third embodiment, a space-saving and low cost apparatus can be achieved.

FIG. 7 is a block diagram of a wavelength determining unit of an optical transmission apparatus according to a fourth embodiment of the present invention. As depicted in FIG. 7, the wavelength determining unit 122 of the optical transmission apparatus 120 according to the fourth embodiment includes a wavelength router (AWG) 701, light receiving elements (PD) 702, and a determining unit 703. The wavelength router 701 outputs an optical signal received by the optical transmission apparatus 120 to a light receiving element that corresponds to the wavelength of the received optical signal, among the light receiving elements 702. The light receiving elements 702 respectively correspond to different wavelengths, and receive optical signals that are output from the wavelength router 701.

The light receiving elements 702 output to the determining unit 703, an electrical signal that corresponds to the intensity of the received optical signal. The determining unit 703 determines the wavelength of the optical signal received by the optical transmission apparatus 120 based on the electrical signal output from the light receiving elements 702. For example, the determining unit 703 determines the wavelength corresponding to the light receiving element that has received an optical signal having the highest intensity as the wavelength of the received optical signal. The determining unit 703 outputs information concerning the determined wavelength to the control unit 125.

As described, according to the optical transmission apparatus 120 of the fourth embodiment, the wavelength of a received optical signal can be determined without passing through a control system. Accordingly, a control system can be omitted while the setting of the transmission wavelength is enabled. Thus, according to the optical transmission apparatus 120 of the fourth embodiment, a space-saving and low cost apparatus can be achieved.

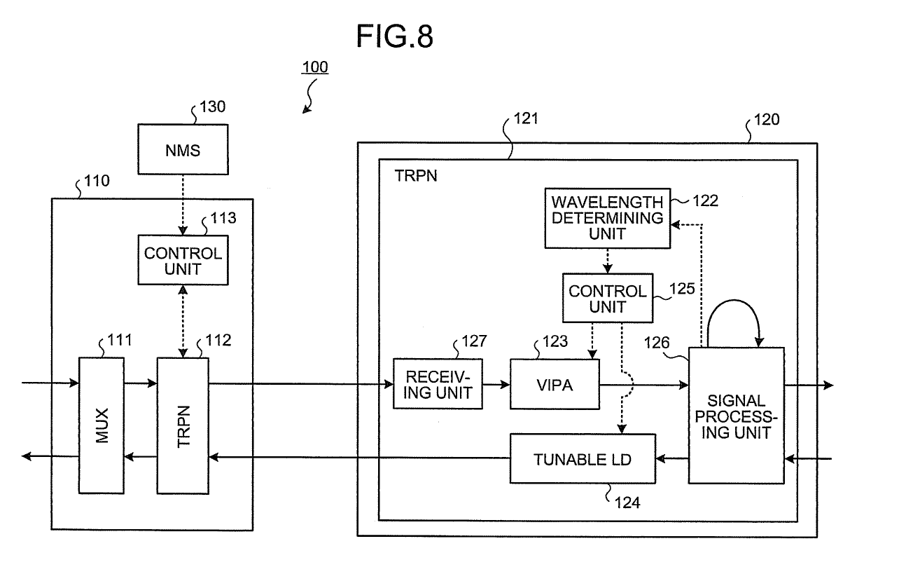

FIG. 8 is a block diagram depicting a part of an optical transmission system to which an optical transmission apparatus according to a fifth embodiment of the present invention is applied. In the optical transmission system 100 to which the optical transmission apparatus 120 according to the fifth embodiment is applied, the WDM apparatus 110 transmits to the optical transmission apparatus 120, an optical signal including information indicating the wavelength by which actual data communication is performed. The signal processing unit 126 of the optical transmission apparatus 120 receives and outputs to the wavelength determining unit 122, the information concerning wavelength transmitted from the WDM apparatus 110. The wavelength determining unit 122 determines the wavelength used at the time of data communication based on the information concerning wavelength transmitted from the WDM apparatus 110.

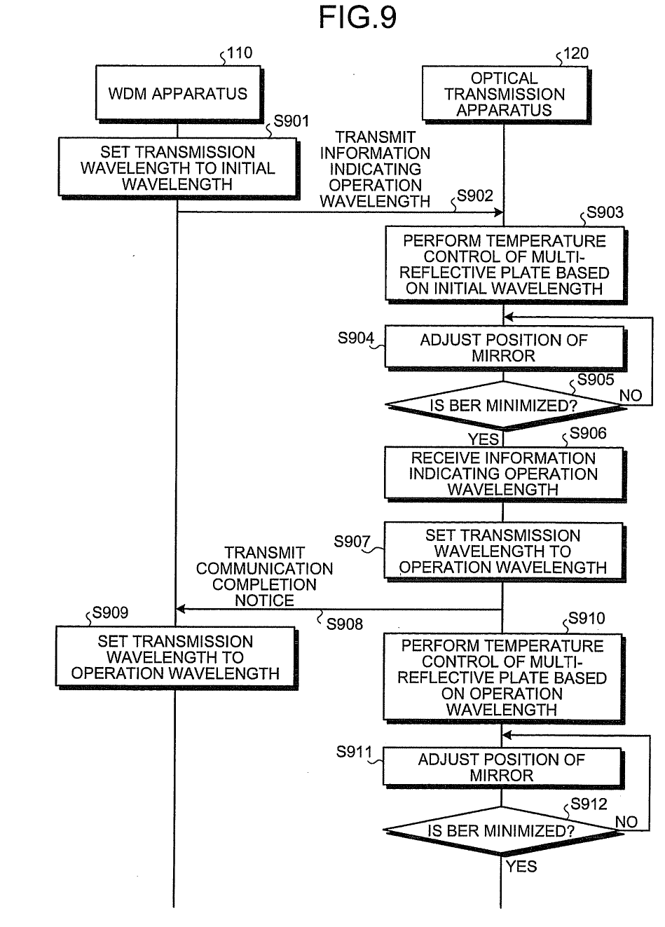

FIG. 9 is a flowchart of an operation of the optical transmission system to which the optical transmission apparatus according to the fifth embodiment is applied. As depicted in FIG. 9, first, the WDM apparatus 110 sets the transmission wavelength of the transponder 112 to a predetermined initial wavelength (step S901). Next, the WDM apparatus 110 transmits to the optical transmission apparatus 120 using available overhead in SONET/SDH, information indicating the operation wavelength used at the time of actual data communication (step S902).

Subsequently, the optical transmission apparatus 120 performs temperature control of the multi-reflective plate 305 based on the initial wavelength (step S903). The optical transmission apparatus 120 then adjusts the position of the mirror 313 (step S904), and continues adjusting the position until BER is minimized (step S905: NO). When BER is minimized (step S905: YES), the optical transmission apparatus 120 receives the information indicating the operation wavelength transmitted from the WDM apparatus 110 (step S906).

Next, the optical transmission apparatus 120 sets the transmission wavelength to the operation wavelength based on the information indicating the operation wavelength received at step S906 (step S907). Subsequently, the optical transmission apparatus 120 transmits to the WDM apparatus 110 using available overhead in SONET/SDH, a communication completion notice indicating that the communication from the optical transmission apparatus 120 to the WDM apparatus 110 has been completed (step S908). The WDM apparatus 110 then sets the transmission wavelength of the transponder 112 to the operation wavelength (step S909).

Next, the optical transmission apparatus 120 performs the temperature control of the multi-reflective plate 305 based on the operation wavelength (step S910). Subsequently, the optical transmission apparatus 120 adjusts the position of the mirror 313 (step S911), and continues adjusting the position until BER is minimized (step S912: NO). When BER is minimized (step S912: YES), the optical transmission apparatus 120 starts data communication. The communication completion notice can be further transmitted from the WDM apparatus 110 to the optical transmission apparatus 120 following step S908.

As described, according to the optical transmission apparatus 120 of the fifth embodiment, the wavelength of a received optical signal can be determined in advance without passing through a control system. Accordingly, a control system can be omitted while the setting of the transmission wavelength is enabled. Thus, according to the optical transmission apparatus 120 of the fifth embodiment, a space-saving and low cost apparatus can be achieved.

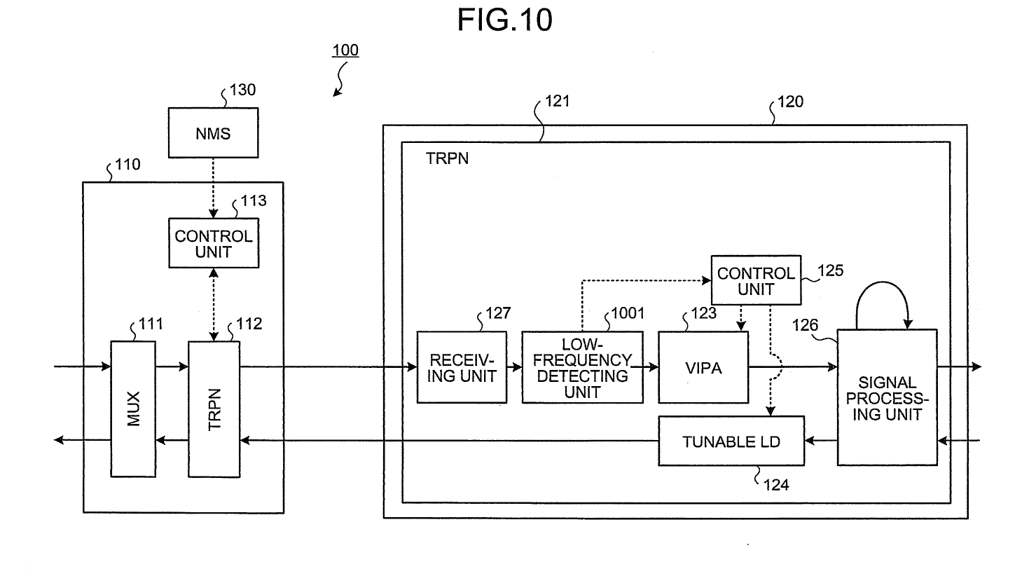

FIG. 10 is a block diagram depicting a part of an optical transmission system to which an optical transmission apparatus according to a sixth embodiment of the present invention is applied. In the optical transmission system 100 to which the optical transmission apparatus 120 according to the sixth embodiment is applied, the WDM apparatus 110 superimposes, as low frequency on an optical signal transmitted by the transponder 112, information indicating the wavelength used at the time of data communication.

The optical transmission apparatus 120 according to the sixth embodiment has a low-frequency detecting unit 1001 in place of the wavelength determining unit 122 of the optical transmission apparatus 120 according to the second embodiment, for example. The low-frequency detecting unit 1001 detects the information that indicates the wavelength used at the time of data communication and is superimposed on the optical signal transmitted from the WDM apparatus 110 as low frequency information. The low-frequency detecting unit 1001 outputs the detected information to the control unit 125. The control unit 125 controls the dispersion compensating unit 123 and the transmitting unit 124 according to the information that is output from the low-frequency detecting unit 1001.

As described, according to the optical transmission apparatus 120 of the sixth embodiment, by detecting information that indicates the wavelength used at the time of data communication and is superimposed on an optical signal that is transmitted from the WDM apparatus 110, the wavelength used at the time of data communication can be determined. Therefore, a control system can be omitted while enabling the setting of transmission wavelength. Thus, according to the optical transmission apparatus of the sixth embodiment, a space-saving and low cost apparatus can be achieved.

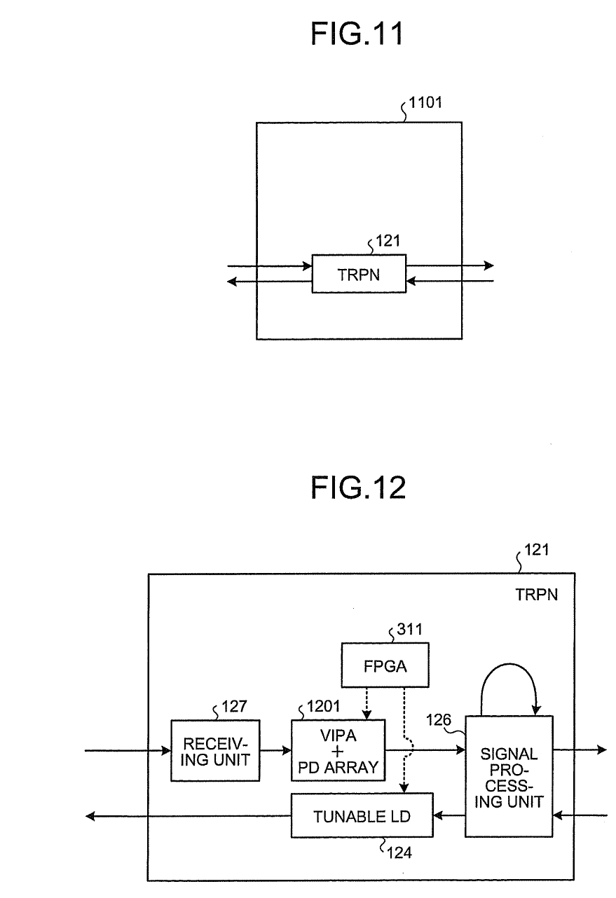

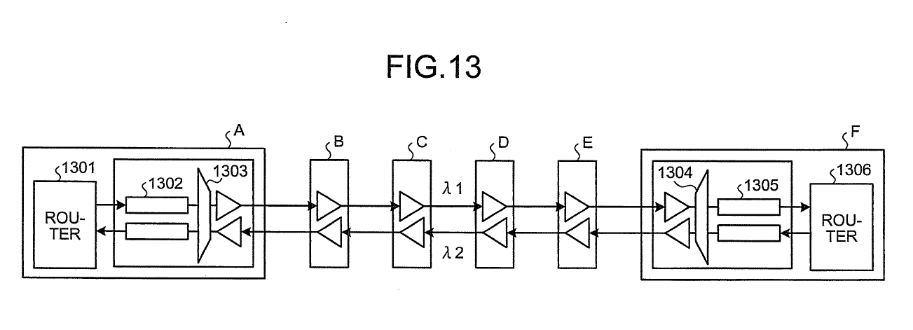

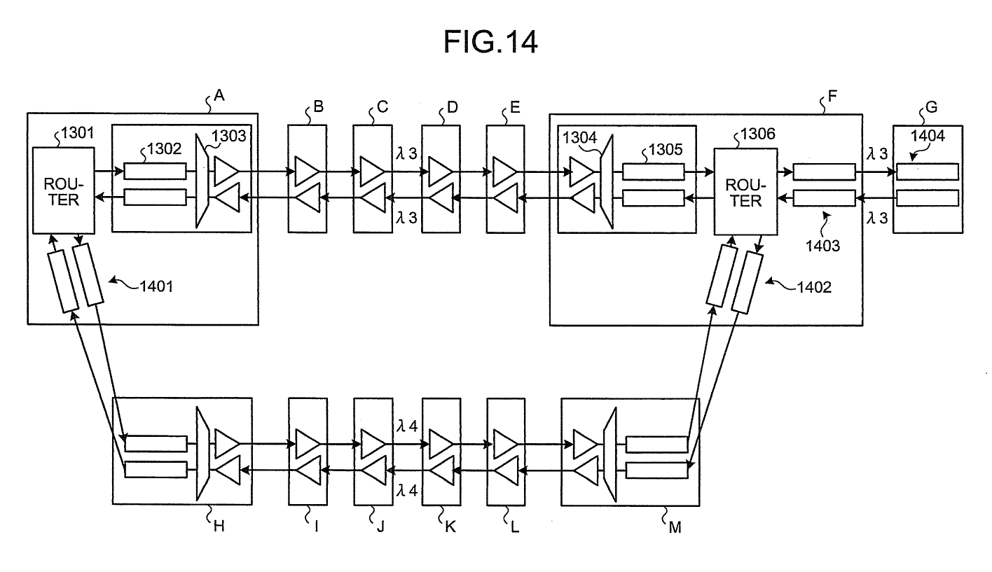

FIG. 11 is a block diagram depicting a basic configuration of an example of a DWDM apparatus to which the optical transmission apparatus according to the present embodiments is applied. As depicted in FIG. 11, a DWDM 1101 to which the optical transmission apparatus according to the present invention is applied includes only the transponder 121 and the control unit 1501 can be omitted. Moreover, connection to the NMS 1510 is not necessary.

FIG. 12 is a block diagram depicting a configuration of an example of the transponder of the optical transmission apparatus according to the present embodiments. As depicted in FIG. 12, when, for example, the optical transmission apparatus 120 according to the second embodiment is applied to the DWDM apparatus 1101, by adding the switching unit 308 and the PD array 309 (VIPA+PD array 1201) to a usual configuration of a VIPA, and by determining a reflection angle of an optical signal on the multi-reflective plate 305, the wavelength of the optical signal is determined. Furthermore, the signal processing unit 126 transmits (as is) alarm information detected for the received optical signal, to a counterpart station (the WDM apparatus 110) using SONET/SDH overhead.

As described above, according to the optical transmission apparatus and the optical transmission method of the embodiments, a control system can be omitted while enabling determination of the wavelength used at the time of data communication. Therefore, according to the optical transmission apparatus and the optical transmission method of the present invention, a space-saving and low cost apparatus can be achieved. Furthermore, according to the optical transmission apparatus and the optical transmission method of the embodiments, connection to an NMS is not necessary, and as a result, installation work can be simplified and costs can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical transmission apparatus comprising:
a receiving unit that receives a first optical signal transmitted from a transmitting device;
a wavelength determining unit that determines wavelength of the first optical signal received by the receiving unit;
a transmitting unit that transmits a second optical signal of varying wavelength; and
a control unit that, based on the wavelength determined by the wavelength determining unit, controls wavelength of the second optical signal transmitted by the transmitting unit.

2. The optical transmission apparatus according to claim 1, further comprising a dispersion compensating unit that performs a variable level of dispersion compensation on the first optical signal received by the receiving unit, wherein
the dispersion compensating unit is configured with a virtually imaged phased array that includes a multi-reflective plate and a free-form mirror, and
the wavelength determining unit determines the wavelength of the first optical signal by determining a reflection angle of the first optical signal on the multi-reflective plate of the virtually imaged phased array.

3. The optical transmission apparatus according to claim 2, wherein
the wavelength determining unit includes
a light receiving unit that receives the first optical signal,
a switching unit that switches between a first state and a second state, the first state in which the free-form mirror is positioned at a given position where the first optical signal reflected on the multi-reflective plate of the virtually imaged phased array is received, the second state in which the light receiving unit is positioned at the given position, and
a determining unit that determines the wavelength of the first optical signal based on the given position of the light receiving unit in the second state.

4. The optical transmission apparatus according to claim 3, wherein
the light receiving unit is configured with a plurality of light receiving elements constituting a photo diode array, and
the determining unit determines the wavelength of the first optical signal based on intensities of light respectively received by the light receiving elements.

5. The optical transmission apparatus according to claim 2, wherein the control unit, based on the wavelength determined by the wavelength determining unit, controls the variable level of the dispersion compensation performed by the dispersion compensating unit.

6. The optical transmission apparatus according to claim 5, wherein the control unit controls the variable level of the dispersion compensation performed by the dispersion compensating unit by performing temperature control of the multi-reflective plate.

7. The optical transmission apparatus according to claim 1, wherein the wavelength determining unit includes
a wavelength router that outputs the first optical signal to a path corresponding to the wavelength of the first optical signal,
a plurality of light receiving elements that are respectively provided on paths from the wavelength router and receive optical signals output from the wavelength router, and
a determining unit that determines the wavelength of the first optical signal based on intensities of light respectively received by the light receiving elements.

8. The optical transmission apparatus according to claim 7, wherein the wavelength router is configured with an arrayed waveguide grating.

9. The optical transmission apparatus according to claim 2, wherein
the control unit, based on a predetermined initial wavelength, controls the variable level of the dispersion compensation performed by the dispersion compensating unit, and
the wavelength determining unit determines the wavelength of the first optical signal based on information transmitted from the transmitting device at the initial wavelength.

10. The optical transmission apparatus according to claim 2, further comprising a detecting unit that detects an optical signal that is transmitted at a frequency lower than the frequency at which the data communication is performed and includes information indicating an operation wavelength that is used when data communication is performed, wherein
the wavelength determining unit, based on the information detected by the detecting unit, determines the wavelength of the first optical signal.

11. An optical transmission method comprising:
receiving a first optical signal transmitted from a transmitting device;
determining wavelength of the first optical signal received at the receiving; and
transmitting a second optical signal corresponding to the wavelength determined at the determining.

12. The optical transmission method according to claim 11, further comprising performing a variable level of dispersion compensation on the first optical signal received at the receiving, wherein
the performing of a variable level of dispersion compensating is performed with a virtually imaged phased array that includes a multi-reflective plate and a free-form mirror, and
the determining includes determining the wavelength of the first optical signal by determining a reflection angle of the first optical signal on the multi-reflective plate of the virtually imaged phased array.
